(19) United States
(12) Patent Application Publication
(10) Pub. No.: US 2011/0096088 A1
(43) Pub. Date: Apr. 28, 2011

(54) ELECTROPHORESIS DISPLAY

(75) Inventors: Cheng-Hao LEE, Hsinchu (TW); Hsin-Chung Chen, Hsinchu (TW); Chao-Ming Tseng, Hsinchu (TW); Kuan-Fu Ting, Hsinchu (TW)

(73) Assignee: Prime View International Co. Ltd.

(21) Appl. No.: 12/774,316

(22) Filed: May 5, 2010

(30) Foreign Application Priority Data
Oct. 27, 2009 (TW) 098136350

(51) Int. Cl. G09G 5/02; G09G 5/00; G09G 3/34

(52) U.S. Cl. 345/596; 345/204; 345/107

(57) ABSTRACT

An electrophoresis display includes a temperature sensor, a memory, a central processing unit and a display unit. The temperature sensor senses and outputs a present temperature. The memory stores a temperature characteristic table. The central processing unit is electrically coupled to the temperature sensor and the memory. The central processing unit receives the present temperature and reads the temperature characteristic table for matching the present temperature with the temperature characteristic table to obtain and output a drive level or timing. The display unit is electrically coupled to the central processing unit for receiving the drive level or timing and displaying according to the drive level.

### CROSS-REFERENCE TO RELATED APPLICATIONS

This application is based upon and claims the benefit of priority from the prior Taiwanese patent application no. 098136350, filed Oct. 27, 2009, the entire contents of which are incorporated herein by reference.

### BACKGROUND

The present invention relates to a transmission of the electrophoresis display. More particularly, the present invention relates to an electrophoresis display including a central processing unit which can generate a driving level or timing and perform a dirthering processing.

With the rise of the soft display, it can replace the present plate display due to its advantages of being light, thin, shock-proof, and flexibility. Therefore, the soft display can be a new type product, for example, e-book, electronic tag, electronic platform or smart card. The electrophoresis display research and development of the present industry comprises microencapsulation electronic ink technic, microcup electrophoresis display technic, and quick response-liquid powder display (QR-LPD). The bistable display is the best choice for a reader having lower frame refresh frequency. The bistable medium has memory functionality so that it only needs to be provided drive voltage on the frame refresh. Thus, it can save power and without frame flicker so that user can read comfortably. The electrophoresis display, QR-LPD, and cholesterol liquid crystal described below may save power and without frame flicker.

FIG. 1 is a schematic block diagram of a part of a circuit of a conventional electrophoresis display. In FIG. 1, the electrophoresis display 100 comprises a central processing unit 102, an input unit 104, a display controller 106, a first memory 108, a second memory 110, a display unit 112, and a temperature sensor 118. Wherein, the central processing unit 102 is coupled to the input unit 104, the display controller 106, and the first memory 108. The display controller 106 is coupled to the second memory 110, the display unit 112, and the temperature sensor 118. The display unit 112 comprises a thin film transistor circuit 114 and a display area 116.

In conventional technique, the second memory 110 stores a temperature characteristic table. The first memory 107 stores the program providing for operation of the central processing unit 102 and the image data. The central processing unit 102 stores the image data stored in the first memory 108 and outputs the image data to the display controller 106. The display controller 106 receives the display controller 106 sensed by a temperature sensor 118 and reads a temperature characteristic table in the second memory 110 for searching a corresponding driving level or timing. Secondly, the display controller 106 outputs the image data and the driving level or the timing to the thin film transistor circuit 114. The thin film transistor circuit 114 drives the display area 116 with the driving level or the timing for employing the display area 116 to display the image data.

### BRIEF SUMMARY

The present invention relates to an electrophoresis display, which may reduce the cost and the power consumption, and may add grayscale number and improve frame quality.

In one aspect of the present invention, the electrophoresis display comprises a temperature sensor, a memory, a central processing unit, and a display unit. The temperature sensor detects and outputs a present temperature. The memory stores a temperature characteristic table. The central processing unit is coupled to the temperature sensor and the memory for performing a matching the present temperature with the temperature characteristic table to obtain and output a driving level or timing. The display unit is coupled to the central processing unit for receiving the driving level or the timing and displaying according to the driving level or the timing.

In an embodiment of the present invention, the image data displayed by the display unit is stored in the memory or a storage unit.

In an embodiment of the present invention, the central processing unit reads the image data stored in the memory or the storage unit for performing an image processing with the image data and outputting the image data to the display unit.

In an embodiment of the present invention, the display unit comprises a display area and a thin film transistor circuit. The thin film transistor circuit is coupled to the central processing unit and the display area for receiving the image data and the driving level or the timing and driving the display area to display the image data with the driving level or the timing.

In an embodiment of the present invention, the electrophoresis display further comprises an input unit. The input unit is coupled to the central processing unit for generating an operation instruction according to operation of user and outputting the operation instruction to the central processing unit.

Because the central processing unit is used to read the driving level or the timing for driving, the use of a display controller and a memory in the electrophoresis display may be avoided. Therefore, the present invention can reduce the cost and the power consumption, and further add grayscale number and improve frame quality.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic block diagram of part circuit of a conventional electrophoresis display.

FIG. 2 is a schematic block diagram of part circuit of an electrophoresis display according to an embodiment of the present invention.

FIG. 3 is a schematic block diagram of part circuit of an electrophoresis display according to another embodiment of the present invention.

FIG. 4A is a schematic diagram of dirthering processing according to an embodiment of the present invention.

FIG. 4B is a schematic diagram of dirthering processing according to another embodiment of the present invention.

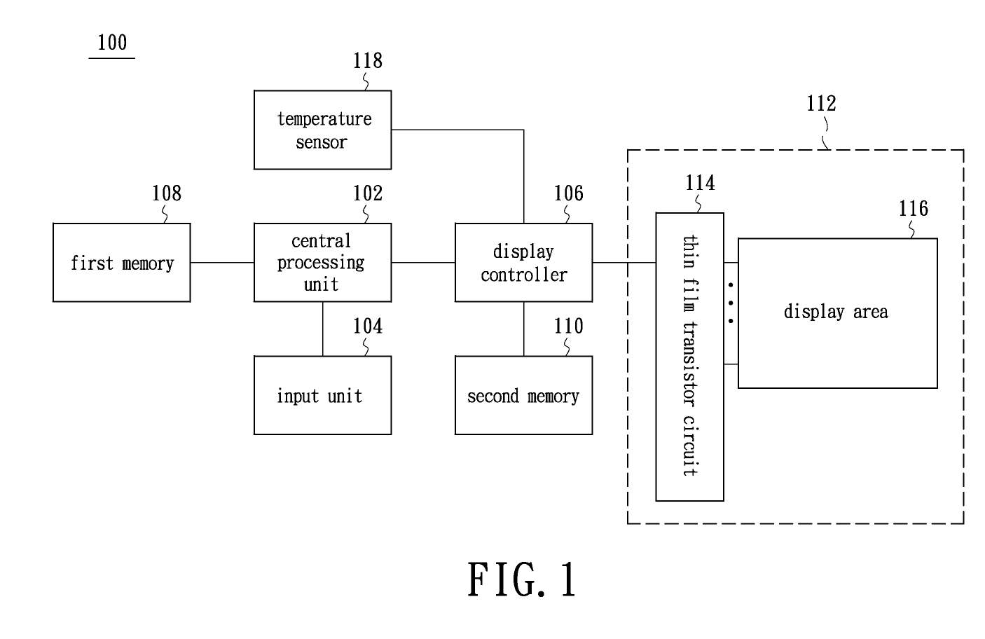

### DETAILED DESCRIPTION

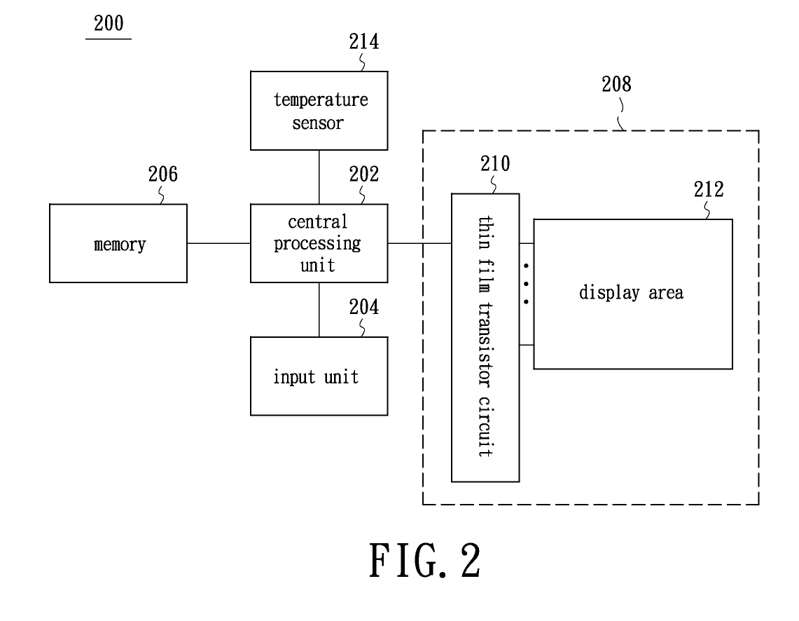

FIG. 2 is a schematic block diagram of part circuit of an electrophoresis display according to an embodiment of the present invention. In the present embodiment, the electrophoresis display 200 comprises a central processing unit 202, an input unit 204, a memory 206, a display unit 208, and a temperature sensor 214.

As illustrated in FIG. 2, the temperature sensor 214 detects a present temperature and outputs the present temperature. Wherein, the temperature sensor 214 detects a present temperature of the display unit 204 and outputs the present temperature to the central processing unit 202 for serving as a reference when the central processing unit 202 drives the display unit 208. Before outputting the present temperature to the central processing unit 202, the temperature sensor 214 transfers the present temperature of analogy signal into the present temperature of digital signal. Wherein, one of ordinary skill person in the art may know that the temperature sensor 214 can be above or around the temperature sensor 214. The present invention, however, is not limited thereto.

The memory 206 stores a temperature characteristic table, an image data and a firmware of operation of the central processing unit 202. The temperature characteristic table is composed of a plurality of temperature ranges and the driving level or the timing, and every temperature range all has its corresponding driving level or timing. Thus, the electrophoresis display 200 can modifies its driving level or timing according to the present temperature. The image data stored in the memory 206 is used to be the image data displayed by the display unit 208. The image data can be burned into the memory 206 or the central processing unit 202 reads from an interface unit (not shown) in the electrophoresis display 200 and temporarily stores the image data therein. The present invention, however, is not limited thereto.

The central processing unit 202 is coupled to the temperature sensor 214, the memory 206, and the display unit 208. The central processing unit 202 receives the present temperature from the temperature sensor 214 and reads the temperature characteristic table stored in the memory 206 after receiving. Wherein, the central processing unit 202 performs a matching process for matching the present temperature with the fields of the temperature characteristic table to obtain a driving level or a timing corresponding to the present temperature. Then, the central processing unit 202 outputs the driving level or the timing to the display unit 208.

In the embodiment, the central processing unit 202 reads the image data stored in the memory 206 and performs an image processing with the image data. Secondly, the central processing unit 202 outputs the processed image data to the display unit 208.

The display unit 208 comprises a thin film transistor circuit 210 and a display area 212. The thin film transistor circuit 210 is coupled to the central processing unit 202 and the display area 212 for receiving the image data and the driving level or the timing transmitted from the central processing unit 202. Wherein, one of ordinary skill person in the art may know that the thin film transistor circuit 210 comprises at least a thin film transistor. The present invention, however, is not limited thereto.

The display area 212 comprises a display array composed of a plurality of scan lines and a plurality of data lines. These scan lines are controlled by the thin film transistor circuit 210. The thin film transistor circuit 210 drives the plurality of scan lines using the driving level or the timing to transmit the image data to the plurality of data lines.

In the embodiment, the input unit 204 is coupled to the central processing unit 202. The input unit 204 generates an operation instruction according to operation of user and outputs the operation instruction to the central processing unit 202. The central processing unit 202 performs a corresponding action according to the operation instruction.

Still referring to FIG. 2, the operation method of the electrophoresis display 200 may be described. After the electrophoresis display 200 is enabled, the input unit 204 outputs the operation instruction to the central processing unit 202 when the input unit 204 receives the operation instruction. The central processing unit 202 performs according to the operation instruction. When the operation instruction is a display instruction, the central processing unit 202 searches and reads a corresponding image data stored in the memory 206 for outputting the image data to the thin film transistor circuit 210. Besides, the central processing unit 202 receives the present temperature transmitted from the temperature sensor 214 and performs a matching process for matching the present temperature with the fields of the temperature characteristic table stored in the memory 206 to obtain a driving level or a timing corresponding to the present temperature. Then, the central processing unit 202 outputs the driving level or the timing to the thin film transistor circuit 210.

When the thin film transistor circuit 210 receives the image data and the driving level or the timing, the display area 212 is driven using the driving level or the timing for displaying the image data on the display area 212.

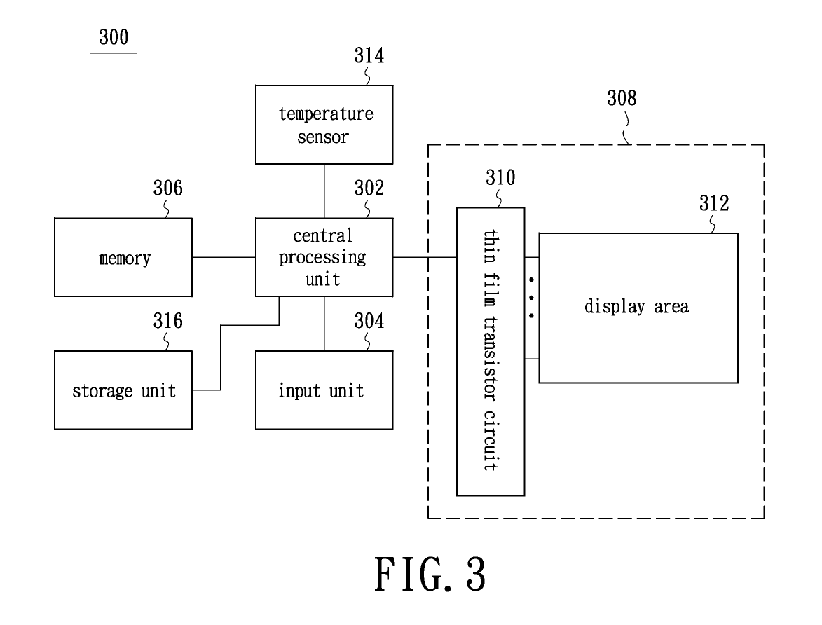

FIG. 3 is a schematic block diagram of a part of a circuit of an electrophoresis display according to another embodiment of the present invention. In the embodiment, the electrophoresis display 300 comprises a central processing unit 302, an input unit 304, a memory 306, a display unit 308, a temperature sensor 314, and a storage unit 316.

As illustrated in FIG. 3, the temperature sensor 314 detects a present temperature and outputs the present temperature. Wherein, the temperature sensor 314 detects a present temperature of the display unit 304 and outputs the present temperature to the central processing unit 302 for serving as a reference when the central processing unit 302 drives the display unit 308. Before outputting the present temperature to the central processing unit 302, the temperature sensor 314 transfers the present temperature of analogy signal into the present temperature of digital signal. Wherein, one of ordinary skill person in the art may know that the temperature sensor 314 can be above or around the temperature sensor 314. The present invention, however, is not limited thereto.

The memory 306 stores a temperature characteristic table, an image data and a firmware of operation of the central processing unit 302. The temperature characteristic table is composed of a plurality of temperature ranges and the driving level or the timing, and every temperature range all has its corresponding driving level or timing. Thus, the electrophoresis display 300 can modify its driving level or timing according to the present temperature. The storage unit 316 stores an image data. The image data stored is used to be the image data displayed by the display unit 308. The image data can be burned in the storage unit 316 or the central processing unit 302 reads from an interface unit (not shown) in the electrophoresis display 300 and temporarily stores therein. The present invention, however, is not limited thereto.

The central processing unit 302 is coupled to the temperature sensor 314, the memory 306, the display unit 308, and the storage unit 316. The central processing unit 302 receives the present temperature from the temperature sensor 314 and reads the temperature characteristic table stored in the memory 306. Secondly, the central processing unit 302 performs a matching process for matching the present temperature with the fields of the temperature characteristic table to obtain a driving level or a timing corresponding to the present temperature. Then, the central processing unit 302 outputs the driving level or the timing to the display unit 308.

In the embodiment, the central processing unit 302 reads the image data stored in the storage unit 316 and performs an image processing with the image data. Secondly, the central processing unit 302 outputs the processed image data to the display unit 308.

The display unit 308 comprises a thin film transistor circuit 310 and a display area 312. The thin film transistor circuit 310 is coupled to the central processing unit 302 and the display area 312 for receiving the image data and the driving level or the timing transmitted from the central processing unit 302. Wherein, one of ordinary skill person in the art may know that the thin film transistor circuit 310 comprises at least a thin film transistor and the amount of the thin film transistor may be decided according to the design. The present invention, however, is not limited thereto.

The display area 312 comprises a display array composed of a plurality of scan lines and a plurality of data lines. These scan lines are controlled by the thin film transistor circuit 310. The thin film transistor circuit 310 drives the plurality of scan lines using the driving level or the timing to transmit the image data to the plurality of data lines.

In the embodiment, the input unit 304 is coupled to the central processing unit 302. The input unit 304 generates an operation instruction according to the operation of user and outputs the operation instruction to the central processing unit 302. The central processing unit 302 performs a corresponding action according to the operation instruction.

Still referring to FIG. 3, the operation method of the electrophoresis display 300 may be described. After the electrophoresis display 300 is enabled, the input unit 304 outputs the operation instruction to the central processing unit 302 when the input unit 304 receives the operation instruction. The central processing unit 302 performs with the operation instruction. When the operation instruction is a display instruction, the central processing unit 302 searches and reads a corresponding image data stored in the storage unit 316 for outputting the image data to the thin film transistor circuit 310. Besides, the central processing unit 302 receives the present temperature transmitted from the temperature sensor 314 and performs a matching process for matching the present temperature with the fields of the temperature characteristic table storing in the memory 306 to obtain a driving level or a timing corresponding to the present temperature. Then, the central processing unit 302 outputs the driving level or the timing to the thin film transistor circuit 310.

When the thin film transistor circuit 310 receives the image data and the driving level or the timing, the display area 312 is driven using the driving level or the timing for displaying the image data on the display area 312.

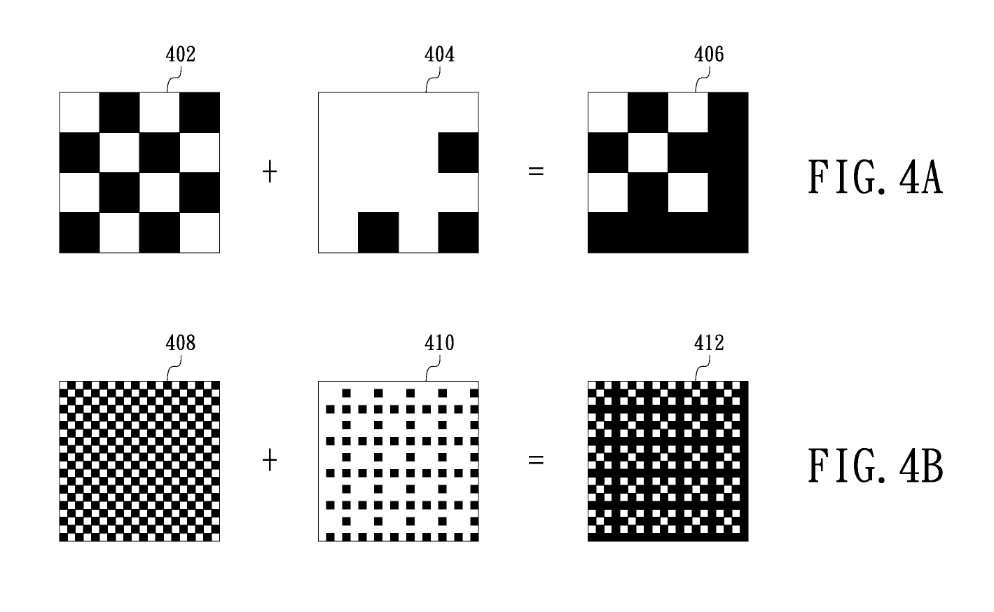

FIG. 4A is a schematic diagram of dirthering processing according to an embodiment of the present invention. In the embodiment, the central processing unit 202 and 302 comprises a dirthering processing when performing the image processing. Wherein, one of ordinary skill person in the art may know that the dirthering processing can be an ordered method, a Floyd-Steinberg method or a Jarvis. The present invention, however, is not limited thereto.

As illustrated in FIG. 4A, the image data 402 and 404 are added in the dirthering processing (white color and black color are described as an example for easily description in the embodiment). The image data 402 and 404 has 16 small grids respectively. When adding, if the corresponding grids of the image data 402 and 404 are all white color, the image data 406 is displayed with white color. If the corresponding grids of the image data 402 and 404 are all black color, the image data 406 is displayed with black color. If one of the corresponding grids of the image data 402 and 404 is black color, the image data 406 is displayed with black color.

FIG. 4B is a schematic diagram of dirthering processing according to another embodiment of the present invention. In FIG. 4B, the image data 408 and 410 are added in the dirthering processing. The image data 408 and 410 has 400 small grids respectively. When adding, if the corresponding grids of the image data 408 and 410 are all white color, the image data 412 is displayed with white color. If the corresponding grids of the image data 408 and 410 are all black color, the image data 412 is displayed with black color. If one of the corresponding grids of the image data 408 and 410 is black color, the image data 412 is displayed with black color.

In a prefer embodiment of the present invention, for example, two gray scale or four scale of the image data can be displayed with sixteen scale or higher scale on the display area 212 and 312 due to the central processing units 202 and 302 performing the dirthering processing using the image data so that it can provide a display value between two gray scale or color scale. Therefore, user can feel a continuation of the gray scale or the color scale of the frame due to effect of persistence of vision of human.

Accordingly, because the central processing unit is used to read the driving level or the timing for driving, a display controller and a memory in the electrophoresis display may be avoided. Therefore, the present invention can reduce the cost and the power consumption and further add grayscale number and improve frame quality.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An electrophoretic display, comprising:
a temperature sensor for detecting and outputting a present temperature;
a memory for storing a temperature characteristic table;
a central processing unit coupled to the temperature sensor and the memory for receiving the present temperature and the temperature characteristic table and performing a matching process for matching the present temperature with the temperature characteristic table to obtain and output a driving level or a timing; and
a display unit coupled to the central processing unit for receiving the driving level or the timing and displaying according to the driving level or the timing.

2. The electrophoresis display of claim 1, wherein the memory stores an image data.

3. The electrophoresis display of claim 2, wherein the central processing unit reads the image data stored in the memory for performing an image process using the image data and outputting the image data.

4. The electrophoresis display of claim 3, wherein the image process is a dirthering process.

5. The electrophoresis display of claim 3, wherein the display unit comprises:
a display area; and
a thin film transistor circuit coupled to the central processing unit and the display area for receiving the driving level or the timing and displaying according to the driving level or the timing.

6. The electrophoresis display of claim 1, further comprises a storage unit coupled to the central processing unit for storing an image data.

7. The electrophoresis display of claim 6, wherein the central processing unit reads the image data stored in the storage unit and performs an image process using the image data for outputting the image data to the display unit.

8. The electrophoresis display of claim 7, wherein the image process is a dirthering process.

9. The electrophoresis display of claim 6, wherein the display unit comprises:
a display area;
a thin film transistor circuit coupled to the central processing unit and the display area for receiving the driving level or the timing and the image data, and displaying the image data according to the driving level or the timing.

10. The electrophoresis display of claim 1, further comprising an input unit coupled to the central processing unit for generating an operation instruction according to operation of user and outputting the operation instruction to the central processing unit.
